(19) United States
(12) Patent Application Publication
(10) Pub. No.: US 2009/0107026 A1
(43) Pub. Date: Apr. 30, 2009

(54) Decoy and Method of Using Same

(76) Inventor: Richard A. Wyant, Red Hook, NY (US)

Correspondence Address: LAW OFFICES OF MICHAEL L. WISE, LLC, 260 WALSH RD., LAGRANGEVILLE, NY, 12540, US

(21) Appl. No.: 12/347,226

(22) Filed: Dec. 31, 2008

Related U.S. Application Data
(63) Continuation of application No. 11/683,349, filed on Mar. 7, 2007.

(51) Int. Cl. A01M 31/06

(52) U.S. Cl. 43/2

(57) ABSTRACT

A decoy comprising: a base member; a hub having a groove along a longitudinal plane of the hub into which a quill end of at least one feather(s) is inserted; and a support operably coupled to the base and to the hub. A decoy, comprising: a distribution means for distributing a tail feather array having a groove along a longitudinal plane of the distribution means into which a quill end of at least one feather(s) is replaceably or permanently inserted; and a reciprocating deployment means for reciprocally deploying the distribution means in positions from about 90 degrees to about 0 degrees with respect to the ground. A method of attracting an adult male turkey, comprising: displaying a decoy characterized by a tail feather array, wherein the tail feathers of a central portion of the array are longer than the tail feathers in a remaining portion of the array.

### CROSS REFERENCES TO RELATED APPLICATIONS

This application is a continuation of prior application Ser. No. 11/683,349, filed Mar. 7, 2007.

### BACKGROUND

1. Field of Use

This invention relates generally to gaming and observation of animals. More particularly, the present invention relates to a decoy mechanism which emulates life-like movements of a fowl, for example, a wild turkey.

2. Background of the Invention

The gaming and observation of animals industry manufactures and sells decoys that may be used to attract wild animals for gaming and observation. Hereinafter, “gaming” includes such activities as hunting and “observation” includes photography.

There is a need for devices in order to attract wild animals, such as for example, fowl, for gaming and observation.

### SUMMARY OF THE INVENTION

A first aspect of the present invention provides a turkey decoy, comprising: a base member; a distribution means for distributing the tail feather array having a groove along a longitudinal plane of the distribution means into which a quill end of at least one feather(s) is replaceably or permanently inserted; and a coupling means for operably coupling the base member to the distribution means.

A second aspect of the present invention provides a turkey decoy, comprising: a distribution means for distributing a tail feather array having a groove along a longitudinal plane of the distribution means into which a quill end of at least one feather(s) is replaceably or permanently inserted; and a reciprocating deployment means for reciprocally deploying the distribution means in positions from about 90 degrees to about 0 degrees with respect to the ground.

A third aspect of the present invention provides a method of attracting an adult male turkey, comprising: displaying a decoy characterized by a tail feather array, wherein the tail feathers of a central portion of the array are longer than the tail feathers in a remaining portion of the array.

A fourth aspect of the present invention provides a method for attracting a Tom Turkey, comprising: positioning a decoy in a face down position in a field, wherein at least one hen(s) and at least one Tom Turkey(s) is present in the field; attracting the hen(s) to the location of the face down decoy using a turkey call; and exposing the decoy, resulting in and the at least one Tom Turkey(s) to the decoy, wherein the at least one Tom Turkey(s) are more attracted to the decoy in the presence of the at least one hen(s) around the decoy than the at least one Tom Turkey(s) would be attracted to either the decoy absent the at least one hen(s) or attracted to the at least one hen(s) absent the decoy.

### BRIEF DESCRIPTION OF THE FIGURES

FIG. 1 depicts a left side elevation view of a decoy, showing a central portion of a tail feather array, in accordance with embodiments of the present invention;

FIG. 2 depicts a top plan view of the decoy, in accordance with embodiments of the present invention;

FIG. 3 depicts a front elevation view of the decoy showing the central portion of the tail feather array as depicted in FIG. 1, in accordance with embodiments of the present invention;

FIG. 4 depicts a left side elevation view of the decoy, in accordance with embodiments of the present invention;

FIG. 5 depicts a left side elevation view of the decoy, before a decoy body has been operably coupled to a hub, before a ground anchor has been inserted, and before the quills of the tail feather(s) of the tail feather array have been replaceably or permanently inserted into the groove of the hub, in accordance with embodiments of the present invention;

FIG. 6 depicts a left side elevation view of the decoy, showing the raising and fanning motion of the tail feathers, in accordance with embodiments of the present invention;

FIG. 7 depicts an elevation view of the decoy, the tail feather array being a protected drawing or photograph of the tail feathers, in accordance with embodiments of the present invention;

FIGS. 8A and 8B depict a bottom plan view of a hub for distributing a tail feather array, in accordance with embodiments of the present invention;

FIG. 9 depicts a rear plan view of the decoy body of the decoy depicted in FIG. 5, showing a pocket for insertion of a person's hand to apply pressure for operably coupling the decoy body to the hub, in accordance with embodiments of the present invention;

FIG. 10 depicts a method for attracting an adult male turkey, according to embodiments of the present invention; and

FIG. 11 depicts a method for attracting a Tom Turkey, according to embodiments of the present invention.

### DETAILED DESCRIPTION OF THE INVENTION

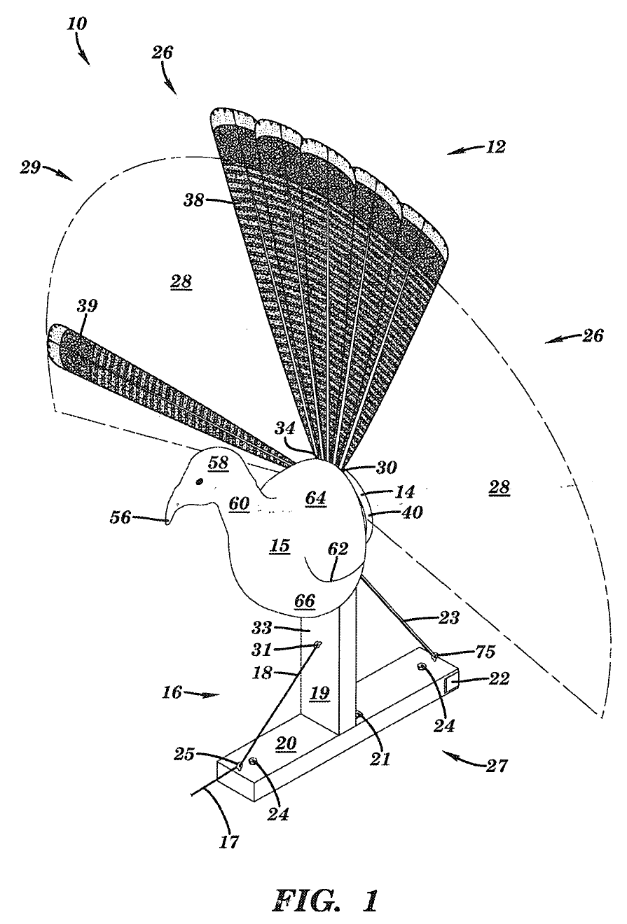

FIG. 1 depicts a left side elevation view of a decoy 10 showing a central portion 12 of a tail feather array 29. The decoy 10 may be used for gaming or observation of wild animals, such as, for example wild turkeys. Alternatively, the device 10 may be used for gaming or observation of any wild or domestic fowl, such as grouse, quail, pheasant, and the like. Hereinafter, “gaming” is defined as any sport that utilizes decoys to attract the game to the location of the observer or hunter, to facilitate photography or hunting the game. Hereinafter, a “decoy” is an artificial likeness of the game, such as, for example a wild turkey. Hereinafter, “observation” is defined as any viewing of wild animals for sport or study, including photography, painting or other forms of rendering the likeness of the animal on a medium of expression such as canvas or film.

During the mating season the wild male turkey will display its tail feathers by spreading them into a semi-circular fan shape as part of the mating strut. The tail feathers begin in a horizontal plane behind the bird and then rise vertically while simultaneously spreading into a fan shape. The action, wherein the tail feathers begin in a horizontal plane behind the bird and then rise vertically while simultaneously spreading into a fan shape hereinafter termed the “raising and fanning motion of the tail feathers” is done to demonstrate the dominance of the male turkey and thus convince a female to mate with him. The female turkey is attracted to the sight of the male turkey's fantail. Because of their competitive nature it has also been observed that male turkeys will also be attracted to the fan tail display. The males will compete for a hen by trying to out strut their fellow turkeys and/or by sparing. The sight of a strutting male will excite and irritate a fellow male turkey. The male turkey then will engage the competitor and attempt to drive them off or try to out strut them. If a male turkey has already gathered a group of females it is very difficult to draw him away from their company. The sight of a competing male turkey that may steal his mates is one of the few things that will pull him away from his group of females.

In theory, decoys 10 that characterize or depict distinguishing physical features of juvenile male birds vs. corresponding physical features of adult male birds such as wing feather shape, tail feather array 29 shape, spur size on legs are most effective for attracting adult male birds for gaming or observation. In theory, the decoy 10, that represents, depicts, or characterizes these outwardly visible physical features operate by increasing the competition among male and juvenile male birds for attracting the female of the species. In addition, the competition among male and juvenile male birds for attracting the female of the species may be enhanced by placing the decoy 10 in close vicinity to female birds of the species. The females may be attracted to a decoy 10 that is hidden by field grass or otherwise not visible to the adult male birds, for example, by orienting the decoy 10 in a prone or horizontal position to the ground. The female birds may be attracted to the location of the decoy 10 using bird calls. Reciprocally deploying the decoy 10, causing it to become visible by raising the decoy 10 to a vertical position with respect to the ground, makes the decoy 10 visible to adult male birds. The adult male birds, sensing the presence of the juvenile male bird in the vicinity of the female birds of the same species may be drawn to the decoy 10 by a sense of competition for the females. More adult males are attracted to the decoy 10, i.e., the decoy 10 is more effective, in attracting adult males when the decoy 10 is deployed in a field in which females of the species are present in comparison to reciprocally deploying the decoy 10 in a field in which the females are absent.

Wing feathers can provide a clue as a rule, upland game birds in Montana (with the exception of ring-necked pheasants) can be effectively aged by looking at their wings. As a group, “gallinaceous birds,” such as the prairie grouse species, mountain grouse and partridge species, molt (replace) their wing and tail feathers in sequence rather than all at once, as is the case with waterfowl. Hereinafter “gallinaceous birds” means heavy-bodied largely ground-feeding domestic or game birds characteristic of the order Galliformes.

As it approaches adult size in the fall, young-of-the-year birds grow wing feathers of adult size during the first, or “postjuvenile” molt. Grouse and Partridge are pretty easy to effectively age. However, in gallinaceous species other than the ring-necked pheasant, the two outer primary feathers on the wing of the young bird are not replaced until one year later and, if the bird should live long enough, annually thereafter. The two outer, primary feathers on a juvenile bird's wing differ in shape from those of an adult. Those juvenile feathers are more pointed at the tip are lighter in color, and sometimes narrower than those found on adults. Unlike Montana's other gallinaceous upland game birds, ring-necked pheasants often replace the two outer, primary feathers during the postjuvenile molt. As a result, immature birds display primaries of adult shape and closely resemble adults. Fortunately, nature has provided another means to determine the age of cock pheasants taken by hunters. Hens are not legal game. The spur on the back of a male pheasant's leg often is used as a criterion of age. Early in the fall, an adult male pheasant will exhibit a much longer spur than a juvenile, with the adult's being perhaps one-inch long and the youngster's one-half inch in length. But because the spur of a young male bird continues to grow all fall and there is some overlap between the spur length of young and old birds late in the fall, this criterion has been found inadequate when standing alone. Therefore, the appearance of the spur during the fall often is used to back up the spur length observation. Adult spurs are visibly sharper as well as longer than those of juveniles.

In general, the male often accompanies several females, and will defend his territory and harem from intruding males, especially juvenile males, in vicious fights.

Wild turkeys are indigenous to North American, including Southern Canada, Central Mexico, Belize, Northern Guatemala, and in parts of Europe. Wild turkeys include a large North American bird (Meleagris gallopavo) that has brownish plumage and a bare wattled head and neck and is widely domesticated for food. A related bird (Agriocharis ocellata) found in Mexico and Central America, is brilliantly colored and has eyelike spots on its tail.

There are 6 subspecies of wild turkey. The differences between them may be found in the References listed below. Subspecies have a 3-part Latin name, instead of the 2-part name for a species. The 6 subspecies are:
1. Eastern wild turkey (Meleagris gallopavo silvestris). This is the most common of the turkeys, and is found in the eastern half of North America from New England and southern Ontario west to Minnesota, Missouri, and Iowa, and south to Texas and northern Florida. It has also been introduced to California, Oregon, and Washington, which are believed to have been outside its original range.
2. Florida wild turkey (Meleagris gallopavo osceola). This turkey is found only on the Florida peninsula. Recent DNA studies show this to be closely related to the eastern subspecies. It may prove to be an invalid subspecies.
3. Gould's wild turkey (Meleagris gallopavo mexicana). The Gould's turkey is now rare. It is found in 7 states along the Sierra Madre mountains in central Mexico and barely enters the U.S. in Arizona and New Mexico.
4. Merriam's wild turkey (Meleagris gallopavo merriami). The Merriam's turkey is native to the mountainous pine regions of the western United States from North Dakota to Oklahoma and west to the Pacific coast. It has been introduced into non-mountainous areas of Nebraska and the west coastal states.
5. Rio Grande wild turkey (Meleagris gallopavo intermedia). The Rio Grande turkey is native to the river valleys of the central and southern Great Plains from South Dakota and Nebraska through Colorado and Kansas to New Mexico and Texas. It has also been introduced to the northwestern states, as well as to Hawaii, Nevada, and Utah.
6. South Mexican wild turkey (Meleagris gallopavo gallopavo). This is the first-described or “nominate” subspecies of the wild turkey. It is believed to be the one from which the domestic turkey was developed. It once inhabited southern Mexico, but is now probably extinct in the wild.

Males are termed “Gobblers” or “Toms” or “Jakes” juvenile, but sexually mature males), females are termed “Hens”, and young are termed Poults. Males, including Jakes, can be almost a meter tall (about 2½-3 feet tall), Males, including Jakes, can weigh up to 11 kg (25 pounds), averaging about 8 kg (17 or 18 pounds). Females (hens) are shorter and weigh about half as much—around 4 kg (9-10 pounds

The mature Gobbler's typical head adornments and “beard” (a hair like appendage hanging from the upper breast) serve as good field marks in distinguishing the male from the female. However, up to 10 percent of the Hens possess beards, and secondly, the Gobbler's beard and head adornments are not readily visible until his second year. The only sure way to tell a gobbler from a Hen is to examine the lower breast feathers. The tips are glossy black in males and white or buffy in females. Glassing turkeys from a distance with binoculars will readily show this difference. The outer two wing feathers will tell you whether the bird is a juvenile or an adult. If the feathers are sharply pointed and without transverse white bars extending to the tip, the bird is a poult (bird of the year). If the outer feather tips are somewhat rounded, and the white bars extend to the tip, the bird is an adult. Hereinafter, a “Jake Turkey” is defined as a sexually mature male wild turkey that is from about one to about two years old.

At daybreak wild Turkeys fly down from their roost. Assembly calls echo through the woods. The calls inform those still roosting of the flock's location. Turkeys still in the tree may yelp back as, one by one, they join the flock. A young male, called a “Jake”, a hen and a gobbler, use a variety of calls to communicate with one another. They're especially vocal in spring.

After spending the Winter in separate flocks, away from the females and young, the Toms gobble to attract the hens. The dominant Tom establishes his position through a series of fights.

### Courtship Display by Toms/Mating

In the presence of the females, the males puff, strut, fan their tails and drag their wing tips. A padding of fat on their chest sustains the Toms through weeks of display. The Jakes and subordinate gobblers are not allowed to mate in the presence of the dominant gobbler. A hen, when ready to be bred, crouches in front of the Tom. Invited with purring sounds, the dominant Tom struts closer. He performs a position dance before beginning fertilization. The gobbler will mate each hen many times, as often as once a day. After each breeding, the hen goes to her nest and lays one egg. This continues until their clutch of ten to twelve is complete. If a lesser Tom wants to join in, but all he can do is watch and masturbate.

Every flock has a hierarchy which is determined by fighting mainly among the gobblers. Hens can fight, though rarely do. The flocks are loose and often exchange birds. Fighting may occur between flocks, or when a stranger arrives. Flock members cooperate; three Toms may confront a newcomer.

Monogamy, the taking of a single mate, is the rule for the vast majority of birds, only about ten percent of all bird species are the like the Turkey, polygamous, having several mates. The Tom Turkey takes no part in rearing the brood. That's the hen's job. The Tom's work is in the intense competition with the other males, and in the simple act of mating. The ceremony, which continues for weeks, is repeated each day at dawn. When each of the hens has a nest full of eggs, they leave the Toms on the strutting ground and begin incubation.

New York State has both spring and fall hunting seasons. The most successful turkey hunters use a variety of calls (e.g., box calls, slate calls, mouth calls) to bring a bird within gun range (usually 30 yards or less). Head-to-toe camouflage helps hunters to stay undetected prior to the shot. The target birds are repelled by movement by the hunter. Few hunting experiences can rival the excitement as a turkey approaches a hunter. Turkey hunters need to be extremely careful, however, before taking a shot.

The excitement of a turkey hunt should sharpen the hunter's awareness of key safety rules. Always identify the target before shooting, and be sure that no other person is in harm's way. Some people are tempted to try to stalk a wild turkey. Forget it! First, it is extremely difficult to approach a turkey undetected. You will be much more successful calling the bird to you. Second, stalking turkeys puts both you and other hunters at risk. Let the bird do the walking.

### Using a Turkey Call

The Turkey hunter must be fully camouflaged and stay perfectly still. A Turkey call is essential equipment. It imitates the “yelp” which a hen uses to attract a Tom. Since most states only allow hunting for gobblers, the idea is to sound like a hen and lure a Tom into gun range. The box call is one of the most popular of the many types of calls, but a gobbler might see the hunter's hands moving. So a diaphragm call, held in the mouth, is another favorite

The wild Turkey is the most prized game bird in America. Though a novice hunter might get lucky, successful Turkey hunting requires skill and practice. Contrary to what some believe the Turkey does not have a high level of intelligence. It does have extraordinary hearing and eyesight.

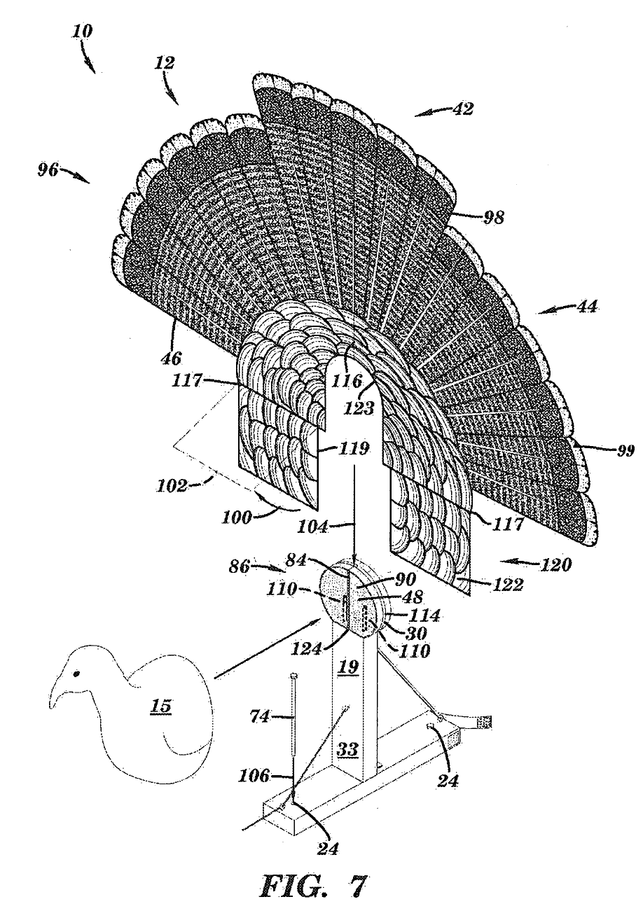

Referring to FIG. 1, the decoy 10 includes a tail feather array 29 of tail feathers, a hub 14, a decoy body 15, and a support 16 made of wood, molded plastic, molded rubber, or any durable solid material. The tail feather array 29 includes a central portion 12 of tail feather(s) 38 and a remaining portion 26 of tail feathers. The central portion 12 of the tail feather array 29 may be characterized by tail feather(s) 38 that may be from about 20% to about 30% longer than the tail feathers 39 of the remaining portion 26. The tail feather array 29 may be made from authentic (natural looking) or artificial (dyed) tail feathers belonging to a Jake Turkey, or to a juvenile sexually mature male grouse, quail, pheasant, and the like. Authentic or artificial tail feathers may be obtained from Steve Warrington, Oostrich.com Inc., 119 N 10th Ave., Melrose Park, Ill. 60160. Alternatively, the tail feather array 29 may be a laminated drawing or photograph of the tail feathers, as depicted in FIG. 7 and described in associated text infra. The lamination may be any appropriate transparent coating on the drawing or photograph such as clear acrylic or the like that will protect the drawing or photograph of the tail feather(s) 38 and 39 from damage from water or inclement outdoor weather common during gaming or observation of wild fowl.

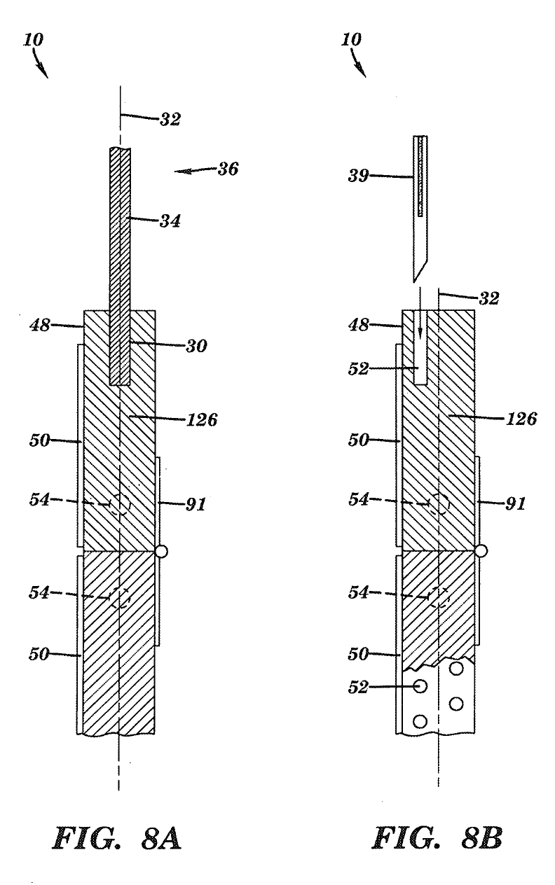

The hub 14 of the decoy 10 may be used for distributing the tail feather(s) 38 of the tail feather array 29 arranged in an array plane 28. In one embodiment, the hub 14 advantageously is a hemisphere 14 having a groove 30 along a longitudinal plane 32 of the hub 14 into which a quill end 34 of at least one feather(s) 38 may be replaceably or permanently inserted, as depicted in FIGS. 1 and 8. In one embodiment, the array plane 28 may advantageously be coplanar with the longitudinal plane 32 of the hub 14. An expanded view 8 of the groove 30 and the longitudinal plane 32 of the hemisphere 14 is shown in FIG. 8, and described in associated text herein. Alternatively, in one embodiment, quill end 34 of at least one feather(s) 38 may be permanently inserted into the groove 30 using an appropriate adhesive such as epoxy. In one embodiment, the hub 14 may have channels 52 along a longitudinal plane 32 of the hub 14 into which a quill end 34 of at least one feather(s) 38 is replaceably or permanently inserted, as depicted in FIGS. 1 and 8, and described in associated text herein. The channels 52 may be oriented in a staggered arrangement in which a location of each successive channel 52 alternates from one side to another side of the longitudinal axis 32, as shown in FIG. 8 or the channels 52 may be oriented along the longitudinal plane 32 of the hub 14 into which a quill end 34 of at least one feather(s) 38 is replaceably or permanently inserted, as depicted in FIGS. 1 and 8, and described in associated text herein.

Alternatively, in one embodiment, the quill end 34 of the each feather(s) 38 of a Jake Turkey's tail feather array 29 may be replaceably or permanently inserted into the groove 30 of the hemisphere 14 running longitudinally along an outer edge 40 of the hemisphere 14 so that the feather(s) 38 of the tail feather array 29 may be uniformly distributed. Hereinafter, “uniformly distributed” is defined as having essentially the same or even spacing between the quill(s) 34 of the feather(s) 38 of the tail feather array 29. In one embodiment, an at least one feather 38 of a central portion 12 of the tail feather array 29 may be longer than an at least one feather(s) 39 of a remaining portion 26 of the tail feather array 29. The preceding embodiment accurately simulates a Jake, because the tail feather(s) 38 of the central portion 12 of a Jake's tail feather array 29 are characteristically longer than the tail feather(s) 39 in the remaining portion 26 of the tail feather array 29.

In one embodiment, the support 16 may be a foldable “T-shaped” support made of wood, molded plastic, molded rubber, or any durable solid material may be used for reciprocally deploying the hub 14 in an upright 72 or level 70 positions with respect to the ground 68, as depicted in FIGS. 1, 3, and 6 and described in associated text infra. Hereinafter “reciprocal deployment” or “reciprocally deploying” is defined as an alternating movement of the hub 14, the decoy body, 15, and the tail feather array 29 from its initial horizontal position with respect to the ground to a vertical or upright position or from about 0 degrees with respect to the ground to about 90 degrees with respect to the ground, including angles between 0 degrees with respect to the ground to about 90 degrees with respect to the ground. The movement of the hub 14, the decoy body, 15, and the tail feather array 29 from its initial horizontal position with respect to the ground to a vertical or upright position is done in order to attract Tom Turkeys or other wild fowl characterized, as are Tom Turkeys, as being attracted to the decoy 10 because the decoy 10 simulates a sexually mature male bird of the year, such as a Jake Turkey. The decoy 10 simulates the sexually mature male bird of the year, such as a Jake Turkey because the decoy 10 has a tail feather array 29, wherein the tail feather(s) 38 of a central portion 12 of the decoy's tail feather array 29 are longer than the tail feather(s) 39 of the remaining portion 28 of the decoy's tail feather array 29, as does the Jake Turkey.

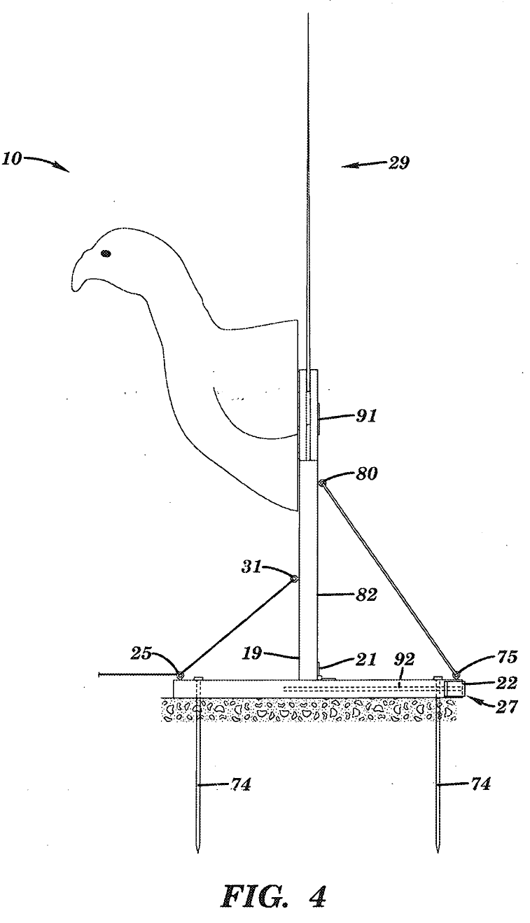

The support 16 may comprise an elongate base member 27. The elongate base member 27 may be an elongate parallelepiped having a surface 20 that faces the lower body 66 of the decoy body 15 when the decoy 10 is deployed in a vertical orientation. Hereinafter “deployed in a vertical orientation” is defined as when the hub 14, including the decoy body, 15, and the tail feather array 29 is moved from its initial horizontal position to a vertical position in an effort to attract Tom Turkeys or other wild fowl. At least two channels 24 traverse the surface 20 and the surface opposite the surface 20. In one embodiment, the base member 27 includes a plurality of channels 92 for housing the spikes or nails 74, and the channels 90 may be covered by releasable tabs 22, as depicted in FIGS. 1 and 4, and described in associated text, infra.

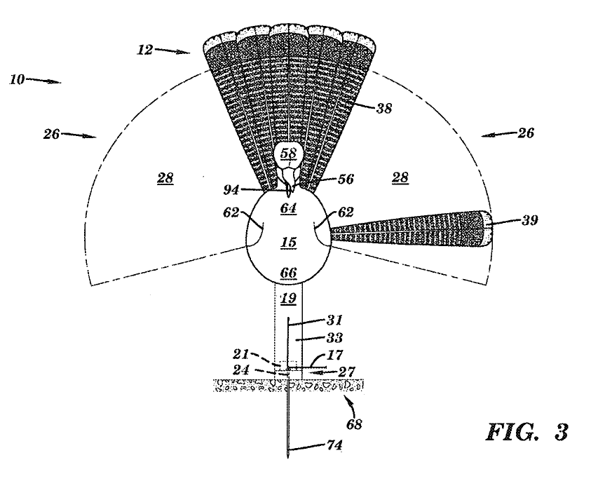

An anchoring device 74, as depicted in FIGS. 3-7, may be inserted through the guide holes 24 and into the ground 68 for anchoring the support 16 when the decoy 10 is being used for gaming or observation of wild fowl. The anchoring device 74 may be spikes, nails, or other appropriate anchoring devices for insertion through the guide holes 24 into the ground 68, as depicted in FIGS. 1, 3, and 6 and described in associated text, infra. At least two fasteners 25 and 75 have been fastened to the surface 20 at opposite ends of the elongate base member 27. The fasteners 25 and 75 may be eyehooks, tacks, or small nails.

The support 16 for operably coupling the elongate base member 27 to the hub 14 may be a hinge 21 directly and physically attaching the elongate base member 27 to the hub 14. Alternatively, the support 16 may be the hinge 21 operably coupled to the elongate base member 27 and to an elongate connecting member 33 having a surface 19. The plane of the surface 19 is parallel to or coplanar with the face 48 of the hub 14. A fastener 31 has been fastened to the surface 19 of the elongate connecting member 33 below the lower portion 66 of the body 15 of the decoy 10. A second fastener 80 has been fastened to a surface 82 that is opposite the surface 19, as depicted in FIG. 4 and described in associated text, infra. The fasteners 31 and 80 may be an eyehook, a tack, or a small nail. Hereinafter “operably coupling” the base member 27 to the hub 14 is defined as physically and mechanically linking the hub 14 to the elongate base member 27 so the hub 14, and the body 15 and tail feather array 29 may be reciprocally deployed.

A drawstring 18 is threaded through the fasteners 25 and 31 and a retrieving device 23 such as an elastic band is operably coupled between the fastener 75 and a faster 80, as depicted in FIG. 4 and described in associated text, infra.

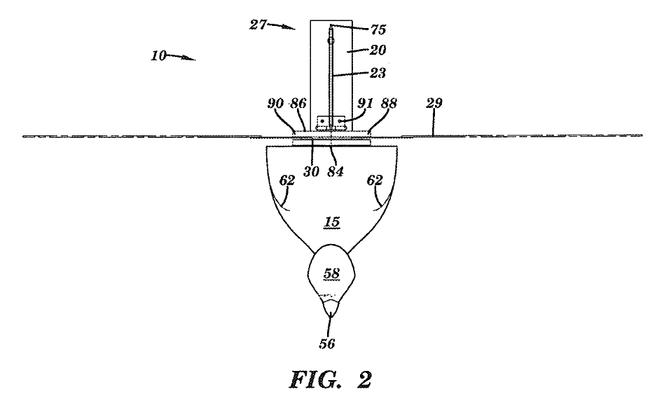

FIG. 2 depicts a top plan view of the decoy 10, the decoy 10, comprising: an elongated base member 27; a hub 14 for distributing the tail feather array 29 having a groove 30 along a longitudinal plane 32 of the hub 14 into which a quill end 34 of at least one feather(s) 38 and 39, is replaceably or permanently inserted; and a support 16 for operably coupling the elongated base member 27 to the hub 14. In one embodiment, the hub 14 comprises a bisected hemisphere 86 having a split 84 along its sagittal axis or plane into mirror image pieces 88 and 90 further comprises a hinged joint 91 that operably couples the mirror image pieces 88 and 90. Hereinafter, the sagittal axis or plane is defined as the median axis or plane of the hub 14.

FIG. 3 depicts a front elevation view of the decoy 10 showing the central portion 12 of the tail feather array 29, as depicted in FIG. 1. The anchoring device 74 may be inserted through the guide holes 24 and into the ground 68 for anchoring the support 16 when the decoy 10 is being used for gaming or observation of wild fowl. The anchoring device 74 may be spikes, nails, or other appropriate anchoring devices for insertion through the guide holes 24 into the ground 68.

FIG. 4 depicts a left side elevation view of the decoy 10 as depicted in FIG. 1 after the decoy 10 has been anchored into the ground 68 by inserting spikes or nails 74 through channels 24. In one embodiment, the base member 27 includes a plurality of channels 92 for housing the spikes or nails 74, and the channels 90 may be covered by releasable tabs 22. In one embodiment, the bisected hemisphere 86 has a split 84 along its sagittal axis or plane into mirror image pieces 88 and 90 further comprises a hinged joint 91 that operably couples the mirror image pieces 88 and 90.

The anchoring device 74 has been inserted through the guide holes 24 and into the ground 68 for anchoring the support 16 when the decoy 10 is being used for gaming or observation of wild fowl. The anchoring device 74 may be spikes, nails, or other appropriate anchoring devices for insertion through the guide holes 24 into the ground 68. At least two fasteners 25 and 75 have been fastened to the surface 20 at opposite ends of the elongate base member 27. The fasteners 25 and 75 may be eyehooks, tacks, or small nails.

A hinge 21 may be used for operably coupling the elongate base member 27 to the hub 14 directly and physically attaching the elongate base member 27 to the hub 14. Alternatively, the hinge 21 may be operably coupled to the elongate base member 27 and to an elongate connecting member 33 having a surface 19. The plane of the surface 19 is parallel to or coplanar with the face 48 of the hub 14. A fastener 31 has been fastened to the surface 19 of the elongate connecting member 33 below the lower portion 66 of the body 15 of the decoy 10. A second fastener 80 has been fastened to a surface 82 that is opposite the surface 19. The fasteners 31 and 80 may be an eyehook, a tack, or a small nail. Hereinafter “operably coupling” the base member 27 to the hub 14 is defined as physically and mechanically linking the hub 14 to the elongate base member 27 so the hub 14, and the body 15 and tail feather array 29 may be reciprocally deployed.

The drawstring 18 is threaded through the fasteners 25 and 31 and a retrieving device 23 such as an elastic band is operably coupled between the fastener 75 and a faster 80.

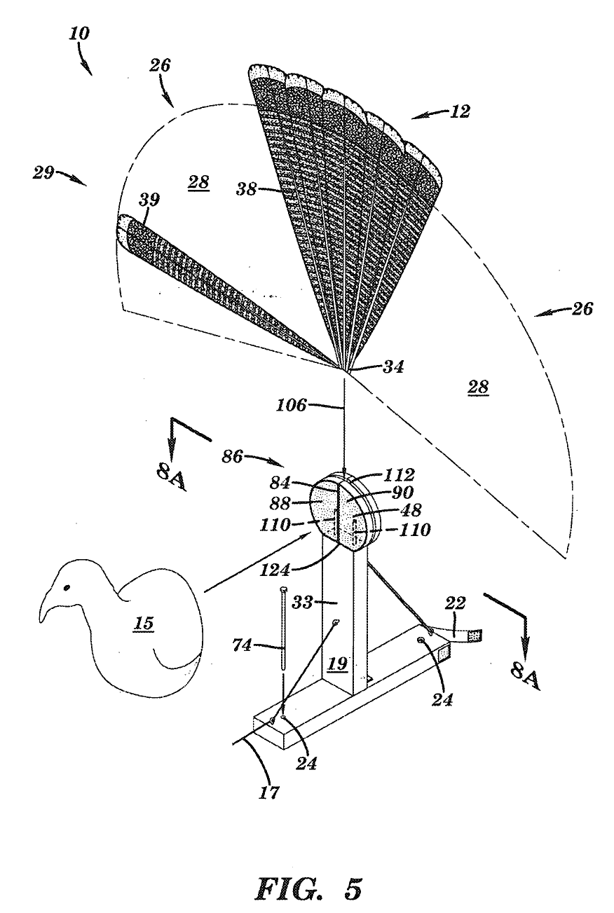

FIG. 5 depicts a left side elevation view of the decoy 10 depicted in FIG. 1. FIG. 5 depicts before the decoy body 15 has been operably coupled to the hub 14, before the ground anchor 74 has been inserted in the direction of the arrow 106 into the at least two channels 24, and before the quills 34 of the tail feather(s) 38 and 39 of the tail feather array 29 have been replaceably or permanently inserted in the direction of the arrow 106 into the groove 112 of the hub 14. In this embodiment, the hub 14 is a bisected hemisphere 86 having a split 84 along its sagittal axis or plane into right and left mirror image pieces 88 and 90 further comprises a hinged joint 91 that operably couples the mirror image pieces 88 and 90. In one embodiment, at least two pins 110 extend from a distal end 124 of the connecting member 33 into openings 54 running along the longitudinal axis 32 of the bottom surface 126 of the hub 14, as depicted in FIG. 8 and described in associated text, infra. In one embodiment, the openings 54 may take a staggered arrangement along the longitudinal axis 32. Hereinafter, “a staggered arrangement of the openings 54” is defined as alternating the location of the openings 54 from one side of the longitudinal axis 32 to the other side.

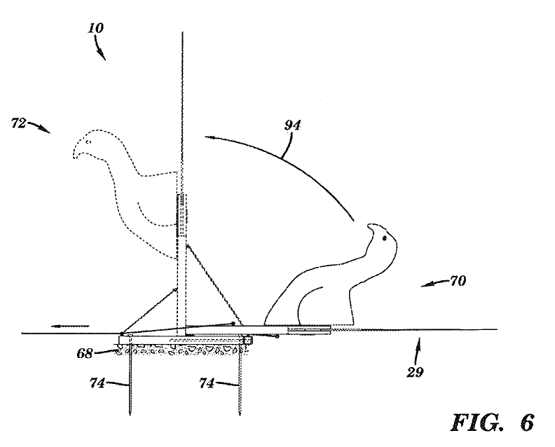

FIG. 6 depicts a left side elevation view of the decoy of FIG. 5, showing the raising and fanning motion of the tail feather array 29. In this embodiment, a foldable support 16 made of wood, molded plastic, molded rubber, or any durable solid material may reciprocally deploy the hub 14 in the direction of the arrow 94 in upright 72 or level 70 positions with respect to the ground 68. The support 16 may be a “T-shaped” structure that includes the base member 27, as depicted in FIG. 1, and associated text, herein.

FIG. 7 depicts a left side elevation view of the decoy 10 of FIG. 5, except that the tail feather array 96 is a protected drawing or photograph of the tail feathers 46 and 98. The tail feather array 96 may be a laminated drawing or photograph of the tail feathers 46 and 98. The lamination may be any appropriate transparent coating on the drawing or photograph such as clear acrylic or the like that will protect the drawing or photograph of the tail feather(s) 38 and 39 from damage from water or inclement outdoor weather common during gaming or observation of wild fowl.

In one embodiment, an edge 99 of the tail feathers 46 and 98 may be brightly colored to warn off or serve as a warning to hunters or other people in the vicinity of the decoy 10. The color may be any bright color such as orange, red, yellow, purple, or any appropriate bright color. The coloring of the edges 99 of the tail feathers 46 and 98 may serve as a safety device because the brightly colored edges may alert hunters of the presence of the decoy 10. Warning hunters that they are in the presence of the decoy 10 increases the safety of hunters in the presence of the decoy 10 because the hunters may be in harm's way in the presence of the decoy 10 if other hunters are firing or shooting arrows or bullets or buckshot in the direction of the decoy 10 in the process of hunting game that is attracted to the decoy 10.

The tail feather array 96 includes a lower portion 120 of body feathers 122 of the tail feather array 96. FIG. 7 depicts before the decoy body 15 has been operably coupled to the hub 14, before the ground anchor 74 has been inserted in the direction of the arrow 106 into the at least two channels 24, and before the edge 123 of the lower portion 120 of body feathers 122 of the tail feather array 96 has been replaceably or permanently inserted in the direction of the arrow 104 into the groove 114 of the hub 14. In this embodiment, the hub 14 is the bisected hemisphere 86 having the split 84 along its sagittal axis or plane into mirror image pieces 88 and 90 further comprises a hinged joint 91 that operably couples the mirror image pieces 88 and 90.

In one embodiment, the tail feather array 96 including the lower body portion 120 of the body feathers 122 of the tail feather array 96 may be bisected along its sagittal axis or plane, forming a seam 116 along which the tail feather array 96 may be folded for easy storage or transportation. Thus, the tail feather array 96 may be stored in a pouch or bag. Thus, the tail feather array 96 and the decoy 10 are easily portable in the pouch or bag. The lower body portion 120 of the body feathers 122 of the tail feather array 96 may be bisected along its transverse axis, forming a seam 117 along which the lower body portion 120 of the body feathers 122 of the tail feather array 96 may likewise be reversibly folded in a direction of the arrow 100 for easy storage or transportation. In one embodiment, when the edge 123 of the lower portion 120 of body feathers 122 of the tail feather array 96 has been replaceably or permanently inserted in the direction of the arrow 104 into the groove 114 of the hub 14, the flap 119 and the plane of the tail feather array 96 are coplanar. When the lower body portion 120 of the body feathers 122 of the tail feather array 96 is folded in the direction of the arrow 100 for easy storage or transportation, the flap 119 may be moved in the direction of the arrow 100 so that it becomes coplanar with the plane 102. The flap 119 becomes positioned for easy storage or transportation by continuing to move it from the plane 102 until the flap 119 becomes parallel with the tail feather array 96.

FIGS. 8A and 8B depict a bottom plan view of a hub 14 for distributing the at least one tail feather(s) 38 and 39 in a tail feather array 29. FIG. 8A depicts a longitudinal cross-sectional view taken along line 8A-8A of FIG. 5. The hub 14 of the decoy 10 for use in part for distributing the tail feather(s) 38 and 39 of the tail feather array 29. In one embodiment, the hub 14 advantageously may be a hemisphere 14 having a groove 30 along a longitudinal plane 32 of the hub 14 into which a quill end 34 of at least one feather(s) 38 may be replaceably or permanently inserted. An expanded view 8 of the groove 30 and the longitudinal plane 32 of the hemisphere 14 is shown. Alternatively, in one embodiment, quill end 34 of at least one feather(s) 38 and 39 may be permanently inserted into the groove 30 using an appropriate adhesive such as epoxy. In one embodiment, the hub 14 may have channels 52 along a longitudinal plane 32 of the hub 14 into which a quill end 34 of at least one feather(s) 38 is replaceably or permanently inserted. The channels 52 may be oriented in a staggered arrangement as shown in FIG. 8 or the channels 52 may be oriented along the longitudinal plane 32 of the hub 14 into which a quill end 34 of at least one feather(s) 38 is replaceably or permanently inserted.

Alternatively, in one embodiment, the hub 14 into which the quill end 34 of the each feather(s) 38 and 39 of a Jake Turkey's tail feather array 29 may be replaceably or permanently inserted into the groove 30 of the hemisphere 14 running longitudinally along an outer edge 126 of the hemisphere 14 so that the feather(s) 38 and 39 of the tail feather array 29 may be uniformly distributed.

Referring to FIGS. 5, 7, and 8, in one embodiment, the at least two pins 110 extend from the distal end 124 of the connecting member 33 of the foldable support 16 into openings 54 running along the longitudinal axis 32 of the bottom surface 126 of the hub 14. In one embodiment, the openings 54 may take a staggered arrangement along the longitudinal axis 32. Hereinafter, “a staggered arrangement of the openings 54” is defined as alternating the location of the openings 54 from one side of the longitudinal axis 32 to the other side.

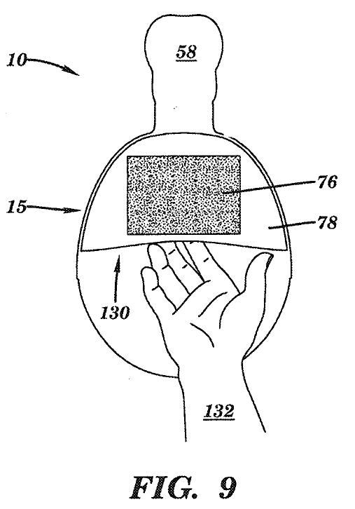

Referring to FIGS. 5 and 8, in one embodiment, the body 15 may be operably coupled to a face 48 of the hub 14 using any appropriate coupling device such as a hinge, a suction grip, an adhesive, a fabric 50 on the face 48 and a fabric 76 on a back surface 78 of the body 15, wherein the fabric 50 and 76 have interlocking ties, or adhesive tape, as depicted in FIGS. 1 and 8 and described in associated text herein. Hereinafter, “operably coupled” or “operably coupling” means physically and mechanically linking the decoy body 15 to the face 48 of the hub 14 using any appropriate attachment 50 such as a hinge, a suction grip, an adhesive, an adhering fabric on the face 48 and an adhering fabric 76 on a back surface 78 of the body 15, wherein the adhering fabric 76 may have interlocking ties, or adhesive tape. The fabric 50 and 76 having interlocking ties is depicted in FIGS. 8 and 9 and may be Velcro®. The adhesive may be silicone, epoxy, or rubber cement. An expanded view 8 of the face 48 of the hub 14 is shown in FIG. 8, and described in associated text herein. The decoy body 15 may be made of molded plastic, polyurethane foam, rubber, or wood, painted or decorated to look like an authentic (natural) turkey body. The decoy body 15 includes a beak 56, a head 58 and a neck 60. The lower portion 66 of the decoy body 15 is separated from the upper portion 64 of the decoy body 15 by a waist 62.

FIG. 9 depicts a rear plan view of the decoy body 15 of the decoy 10 depicted in FIG. 5, showing a pocket 130 for insertion of a person's hand 132 to open the pocket 130 and in so doing apply pressure for operably coupling the decoy body 15 to the hub 14. In one embodiment, a body attachment 50 for operably coupling the decoy body 15 to a face 48 of the hub 14 may be any appropriate body attachment 50 such as a hinge, a suction grip, an adhesive, or an adhering fabric. In one embodiment, the body attachment 50 may be an adhering fabric on the face 48 of the hub 14 and an adhering fabric 76 on a back surface 78 of the body 15, wherein the adhering fabric 76 has interlocking ties, or is adhesive tape. Hereinafter, “operably coupled” or “operably coupling” means physically and mechanically linking the decoy body 15 to the face 48 of the hub 14 using any appropriate attachment 50 such as a hinge, a suction grip, an adhesive, an adhering fabric on the face 48 and an adhering fabric 76 on a back surface 78 of the body 15, wherein the body attachment 50 and the adhering fabric 76 may have interlocking ties, or adhesive tape. The body attachment 50 or the adhering fabric 76 having interlocking ties is depicted in FIGS. 8 and 9 and may be Velcro®. The adhesive may be silicone, epoxy, or rubber cement.

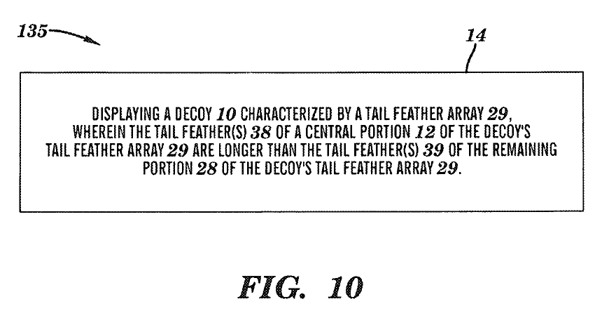

FIG. 10 depicts a method 135 for attracting an adult male turkey, comprising: a step 140, displaying a decoy 10 characterized by a tail feather array 29, wherein the tail feather(s) 38 of a central portion 12 of the decoy's tail feather array 29 are longer than the tail feather(s) 39 of the remaining portion 28 of the decoy's tail feather array 29.

In one embodiment of the method 135, the centrally disposed feathers are from about 10 to about 30 percent longer than the outwardly disposed feathers in the array.

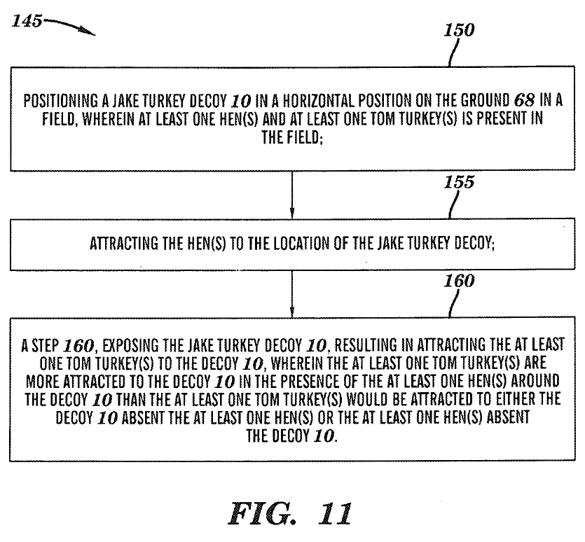

FIG. 11 depicts a method 145 for attracting a Tom Turkey, comprising: a step 150, positioning a decoy 10 in a horizontal position on the ground 68 in a field, wherein at least one hen(s) and at least one Tom Turkey(s) is present in the field; a step 155, attracting the hen(s) to the location of the decoy 10; and a step 160, exposing the decoy 10, resulting in attracting the at least one Tom Turkey(s) to the decoy 10, wherein the at least one Tom Turkey(s) are more attracted to the decoy 10 in the presence of the at least one hen(s) around the decoy 10 than the at least one Tom Turkey(s) would be attracted to either the decoy 10 absent the at least one hen(s) or would be attracted to the at least one hen(s) absent the decoy 10. In the exposing step 160, a person orients the array from about 90 degrees to about 0 degrees including angles between 90 degrees to about 0 degrees with respect to the ground by pulling the drawstring 18 that is threaded through the fasteners 25 and 31, at any point 17 that is between the person and the fastener 25 in order to overcome an opposing force generated by the retrieving device 23. The retrieving device may be an elastic band 23 that is operably coupled between the fastener 75 and a faster 80, as depicted in FIG. 4 and described in associated text, supra. In an embodiment, the method 145 comprises a step 165, returning the decoy 10 to the horizontal position with respect to the ground whereby the person releases the drawstring 18, at any point 17 that is between the person and the fastener 25 in order to allow the retrieving device 23 to return the decoy 10 to the horizontal position with respect to the ground.

What is claimed is:

1. A decoy comprising:
a base;
a coupling member attached to the base;
a mounting member attached to the coupling member;
a representation of an array of feathers, the representation mounted on the mounting member; and
a drawstring operative to cause the coupling member to pivot in relation to the base.

2. The decoy of claim 1, further comprising a decoy body attached to the mounting member.

3. The decoy of claim 1, wherein the coupling member is attached to the base by a hinge.

4. The decoy of claim 1, wherein the drawstring is attached to the coupling member.

5. The decoy of claim 1, wherein the mounting member defines a groove in which the representation is at least partially inserted.

6. The decoy of claim 1, further comprising an elastic member or spring spanning between the base and the coupling member, the elastic member or spring configured to elastically bias the coupling member to pivot in a given direction in relation to the base.

7. The decoy of claim 6, wherein drawing the drawstring away from the base is operative to pivot the coupling member in a direction opposite to the elastically biased direction.

8. The decoy of claim 1, wherein the representation depicts an array of wildfowl tail feathers.

9. The decoy of claim 8, wherein the representation of the array of wildfowl tail feathers depicts at least two tail feathers having different lengths.

10. The decoy of claim 1, wherein the representation depicts wildfowl tail feathers and wildfowl body feathers.

11. The decoy of claim 1, wherein the base defines a plurality of holes.

12. The decoy of claim 1, wherein the base comprises a plurality of channels and tabs adapted to hold spikes or nails.

13. The decoy of claim 1, where the representation comprises seams adapted to allow the representation to be folded in a predetermined manner.

14. The decoy of claim 1, wherein the representation comprises a drawing.

15. The decoy of claim 1, wherein the representation comprises a photograph.

16. The decoy of claim 1, wherein the representation is at least partially laminated.

17. The decoy of claim 1, wherein at least two pins extend from an end of the coupling member into opening in an outer edge of the mounting member.

18. The decoy of claim 1, wherein the coupling member comprises a parallelepiped.

19. The decoy of claim 1, wherein the mounting member comprises two mirror-image portions that are hingedly attached to one another.
